(19) United States
(12) Patent Application Publication
(10) Pub. No.: US 2014/0279334 A1
(43) Pub. Date: Sep. 18, 2014

(54) MANAGING WORKFLOW FOR CLOSING A REAL PROPERTY ASSET TRANSACTION

(71) Applicant: Auction.com, LLC, Irvine, CA (US)

(72) Inventors: Jennifer Leuer, Irvine, CA (US); John Hood, Irvine, CA (US)

(73) Assignee: Auction.com, LLC, Irvine, CA (US)

(21) Appl. No.: 14/214,694

(22) Filed: Mar. 15, 2014

Related U.S. Application Data
(60) Provisional application No. 61/800,658, filed on Mar. 15, 2013.

(51) Int. Cl. G06Q 50/16; G06Q 10/10

(52) U.S. Cl. CPC G06Q 50/167; G06Q 10/10
USPC 705/35

(57) ABSTRACT

A method for managing closing workflow of a real property asset transaction through use of a computing device is provided. Requests are dispatched to provide information concerning the parties involved in the transaction. Closing-related actions are automatically associated to the identified parties. The actions are automatically scheduled in accordance with a timeline of due dates. The actions and due dates are automatically communicated to the parties, and completion of each action is monitored via networked communication with the parties.

### RELATED APPLICATION

This application claims the benefit of priority to Provisional U.S. Patent Application No. 61/800,658, filed Mar. 15, 2013, entitled MANAGING WORKFLOW FOR CLOSING A REAL PROPERTY ASSET TRANSACTION; the aforementioned priority application being hereby incorporated by reference in its entirety.

### TECHNICAL FIELD

Examples described herein pertain generally to a system and method for managing workflow for closing a real property asset transaction through use of computing devices.

### BACKGROUND

Closing a real property asset transaction, such as a sale of residential or commercial real estate, often involves coordinating a defined timeline of actions that are typically carried out by multiple parties. Inefficient workflow delays in completing certain actions may cause other delays in the process that may undesirably increase costs and raise the risk of a deal falling through. There are some instances where costs involved in closing real estate asset transactions may be reduced by minimizing agent involvement.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example system for managing workflow involved in closing a real estate transaction through use of networked computing devices;

FIG. 2 illustrates an example method for coordinating preliminary closing procedures for a real estate transaction using networked computing devices;

FIG. 3 illustrates an example method for coordinating final closing procedures for a real estate transaction using networked computing devices;

FIG. 4 illustrates an example dynamic workflow for closing a real property transaction; and

FIG. 5 is a block diagram that illustrates a computer system upon which some embodiments described herein may be implemented.

### DETAILED DESCRIPTION

Examples described herein provide a system and computer-implemented method for managing workflow involved in closing procedures for a real property asset transaction. Online automated scheduling, tracking, and overall coordination between multiple parties allows for efficient activity management to minimize costs and risks involved in the transaction.

According to an example, a computer-implemented method for managing closing workflow of a real property asset transaction involves dispatching requests to provide information concerning the parties involved in the transaction. Closing-related actions are automatically associated to the identified parties. The actions are automatically scheduled in accordance with a timeline of due dates. The actions and due dates are automatically communicated to the parties, and completion of each action is monitored via networked communication with the parties.

In accordance with a further example, a system for managing workflow of a closing process associated with a real estate transaction is disclosed. The system includes a computing device such as a server or other computing platform. A request module under control of the computing device is operative to prompt and gather information from parties involved in the real estate transaction. A scheduling module under control of the computing device receives the gathered information from the request module to generate a scheduled workflow of action items. A network interface communicates the scheduled workflow of action items to the parties involved in the real estate transaction.

Among other benefits, examples described herein achieve a technical effect in which programs and operations that require access to resources of a network-based file system are performed significantly faster than more conventional approaches. For example, programs can asynchronously issue file system operation requests from the network-based file systems in order to implement programs such as copying directories. In turn, these programs can complete their objectives at a speed that is based on efficient utilization of the network's maximum transmission unit (MTU) and maximum bandwidth. Accordingly, examples such as described enable certain programs that require use of network-based file systems to complete their objectives in a fraction of the time as compared to more conventional approaches that rely on synchronous, message-based communications as between the client terminal and the network-based file systems.

As used herein, an “asset” may refer to an interest in real property, such as residential or commercial real estate. Also as used herein, a “user” may refer to an individual operating a computing device. An example of a user may include an owner of a real property asset, an asset evaluator, a home inspector, an appraiser, etc.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component may include a program, a sub-routine, a portion of a program, or a software component or a hardware component capable of performing one or more stated tasks or functions. As used herein, a module or component may exist on a hardware component independently of other modules or components. Alternatively, a module or component may be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### SYSTEM DESCRIPTION

FIG. 1 illustrates an example system, generally designated 100, that automatically manages workflow activities involved in a closing of a real property asset transaction. According to some examples, the system 100 can be implemented through software that operates on various computing platforms, such as a general-purpose computer, a web-based server, and/or mobile computing device. System 100 can also be implemented through other computer systems in alternative architectures (e.g., peer-to-peer networks, etc.). System 100 can also be configured to communicate with one or more public services 160 that can, for example, provide a way to record closing documents with a government entity, as more fully explained below.

In one example, the system 100 includes a centralized computer such as a server 102 and multiple party interfaces 104 and 106 that provide network access to the system 100 via respective network connections 108 and 110. Furthermore, examples described with respect to FIG. 1 achieve a technical effect in which programs and operations that require access to resources included in FIG. 1 are performed significantly faster than more conventional approaches. Such components as shown can be programmatically employed to complete their objectives at a speed that is based on efficient utilization of the network's maximum transmission unit (MTU) and maximum bandwidth. Accordingly, examples such as described enable certain programs that require use of network-based file systems to complete their objectives in a fraction of the time as compared to more conventional approaches that rely on synchronous, message-based communications as between the client terminal and the network-based file systems.

In an example of FIG. 1, each network connection may support access to the system via remote computing devices 112 and 114 that generally correspond to each of the parties, whether general purpose computers or mobile computing devices such as laptops or mobile phones. Each of the remote computing devices 112 and 114 generally employ an application interface 116 and 118 driven by processing resources 120 and 122. The application or software interface communicates with the system 100 in terms of various scheduling and tracking services are more fully explained below.

Configuration of a given system flow for a given transaction begins with a request module 124 that solicits information from one or more of the parties in the form of prompts. The prompts generally facilitate the entry of data necessary in automating a workflow for the closing process. The data may include, for example, the identification of all parties including names, addresses, affiliated organizations, email addresses, and other forms of contact information. Data relevant to the specific transaction deal points are also provided, such as the length of escrow, specific contingencies, specific escrow responsibilities, and so forth. In some embodiments, the geographic location of the real property asset may be requested. Further, the type of real property asset may also be requested.

Further referring to FIG. 1, the data elicited by the request module is fed to a scheduling module 126. The scheduling module generates a list of required actions, a responsible party for each action, and a deadline for each action. In many instances, the overall timeline for a given series of actions is dynamic, with many deadlines being dependent upon completion of other deadlines. The scheduling module automatically takes this into account in generating the workflow. For example, the scheduling module 126 may automatically assign the buyer certain actions 127 involving obtaining a preliminary loan approval, obtain home and/or pest inspections, remove contingencies (such as selling existing home, obtaining mortgage at a certain rate, etc.). In a similar manner, a lender involved in the transaction may receive actions 128 involving obtaining an appraisal, obtaining underwriting approval of the loan, order loan documents, etc. Other parties that may receive actions might involve the seller 129, a closing agent 130 and a title agent 132. In some embodiments, the scheduled workflow and actions may be based on the type of real property asset, or the asset's geographic location.

Further referring to FIG. 1, the scheduling module 126 may have a minimal threshold of required data in order to generate a scheduled workflow. In the event the required data is not provided in the initial prompts from the request module 124, additional information requests are solicited from one or more parties via the network. As sufficient data is made available, and a complete schedule of actions developed, the scheduling module 126 may communicate with the parties via the network by generating emails or other prompts to the relevant parties informing them of their responsibilities to carry out a given action by a given due date. The initial workflow prompts may also include accompanying documents, such as, for example, a preliminary settlement statement for the buyer and seller. Accompanying documents may be generated by a document processor module 134 that interfaces with the scheduling module 126. All data, the scheduled workflow and all documents involved in the transaction may be stored in a database 136.

The scheduling module 126 also provides a tracking function and may be programmed to check the status of certain actions at predetermined timing intervals. Checking the status may involve sending reminder emails or in some cases regenerating a scheduled workflow due to one or more missed deadlines or early action completions. In some embodiments, the scheduling module may provide data to a graphical user interface (GUI) that allows for any of the parties to identify a current status of pending actions and how a given closing timeline may be affected by certain actions.

In some examples, a services interface 160 may provide access to one or more services 170 (e.g., to one or more computing devices or servers remote from system 100). The services can include those that access city websites 140 and country records 142. In particular, the service interface 160 can use one or more network resources of the computing device to provide communications over a wireless network. The network resources can include, for example, a cellular data/voice interface to enable the device to receive and send network communications over a cellular transport. As an alternative or variation, the network resources can include a wireless network interface for connecting to access points (e.g., Wireless Fidelity 802.11(g) or 802.11(n)) or for using other types of wireless mediums (e.g., Wi-Max). The service interface 160 can also format the presentation from a first format to a second format based on the particular service 170 that is to receive the report 161 (e.g., formatted as a PDF file, HTML file, or XML file, etc.).

The services 170 can include, for example, email services (so that the scheduled workflow and/or status of actions can be provided to the user's and/or different parties' email addresses), banking services, real estate management services, governmental agencies, and/or online transactional services.

### METHODOLOGY

FIG. 2 illustrates an example method for managing preliminary workflow activities involved in closing a real estate transaction. A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described.

The method steps set forth in FIG. 2, in one embodiment, correspond to initial activities carried out as part of escrow creation, and are initiated in response to a preliminary engagement request on the part of one or more parties involved in a real estate transaction. In the interests of achieving enhanced efficiency, reduced costs, and reduced risk in managing the transaction, the parties may agree to have the workflow managed automatically by the computer implemented method described herein.

Referring to FIG. 2, the initial engagement request triggers the request module 124 to begin a detailed series of prompts where the answers provide detail necessary for the system to generate a schedule. The detail may involve information concerning the parties, the real estate transaction, and anything else that might affect a scheduled timeline, at 202. Critical details such as the agreed-upon escrow length (in terms of days), contingencies, or other time-critical items may be flagged for special handling by the system 100.

Once the information is entered by the request module, the scheduling module 126 generates a workflow based on the entered information, at 204. The workflow includes specified actions, a party responsible for completing the action, and a due date. The generated workflow may then be approved by a designated party leader. Once approved, a series of scheduled instructions for actions may be dispatched to the relevant parties as prompts, emails, text, or the like, at 206. The instructions may take the form of a reminder that a given action is due for completion in a set period of time. The action may also note any dependencies that other actions may have on the given action.

Each action that is sent out by the scheduling module 126 may be periodically tracked, at 208, via programmable durations, and reminders sent to the responsible parties. For some embodiments, an interface may be provided for the parties to access the system and view the status of one or more actions, at 210. Documents that are signed and stored by the system may also be made available in a repository for one or more of the parties to review, at 212.

Further referring to FIG. 2, a key action that is often related to a contingency involves an inspection of the real property asset. The inspection is typically ordered by the buyer, and carried out by a third party inspector. Generation of an inspector report may often take several days. Thus, ordering, carrying out, and receiving an inspection report may take from one to two weeks. Further, a buyer may negotiate that the transaction is contingent upon an acceptable inspection report. Should the buyer desire to renegotiate the deal based on the inspection report, delays in escrow may result. Thus, the scheduling module 126 regularly determines whether a given inspection is completed, at 214, and if not, automatically reminds the buyer that the inspection is due at a certain time.

Another critical item often involved in the closing process involves obtaining an appraisal of the property. This item is unnecessary in rare cases where all cash offers are tendered, but in most cases, an appraisal report is needed. The scheduling module 126 regularly monitors this item, at 216, and automatically sends reminders to the lender via the network. Once the appraisal report is finished, and the appraisal adequately reflects the negotiated price of the real property, a copy of the report may be stored in the system repository.

Other key actions involved in the preliminary closing process involve removing all contingencies, at 218, and confirming that the loan for the buyer has actually been approved by the underwriting department associated with the lender, at 220. Again, as the scheduling module tracks these actions, and sees that they are not completed, reminders are automatically sent to the responsible parties, at 206. However, once all of the preliminary actions are completed (indicated by responses from the parties and copies of relevant documents), a final closing sequence may begin (indicated by following bubble “A” to FIG. 3).

FIG. 3 illustrates one embodiment of a method that corresponds to a final closing process where, in one embodiment, all preliminary actions have been accomplished (such as through the steps shown in FIG. 2). With a confirmed loan underwriting approval, a confirmation that loan documents have been ordered is carried out, at 302. In some embodiments, the software generates an order request for the loan documents through the lending entity of record. Final settlement documents are also generated, at 304, reflecting any changes in loan terms or escrow terms that may have occurred during the escrow period. In some jurisdictions, a buyer has a right to review the final settlement sheet within a certain time of the final closing date, and the scheduling module may take this into account.

Further referring to FIG. 3, the scheduling module 126 coordinates with the document processing module 134 to determine whether all final closing documents are ready for signature, at 306. Once the documents are ready, copies are attached to communications dispatched by the scheduling module 126 to the various parties, at 308, with specific instructions to review, sign, and return signed versions of the documents to the system 100 via networked communication. In some embodiments, the application interface provides for electronic reviews and electronic signatures for the parties.

After the documents have been sent out for signature via the network, the scheduling module 126 tracks the status of the documents in terms of whether a given party has returned a signed copy, at 310. Periodic determinations are made, at 312, in an effort to keep the various parties abreast of the closing status, which is made available to all parties via the platform. Once all of the signed documents have been returned, the document processor module 134 aggregates and collates the documents, at 314, for appropriate formatting for recordation. The document package may then be electronically sent to the local Recorders office, where it is recorded, at 316 via the services interface 160. The system 100 monitors the status of the recording process, at 318, and sends a confirmation communication once recording of the documents has been detected, at 320.

FIG. 4 illustrates an example dynamic workflow for closing a real property transaction. After all parties have been identified, and all requests have been complied with, the scheduling module 126 generates a dynamic workflow 400, which includes a workflow schedule 404 that lists the tasks to be performed by each party and a due date for each task. The dynamic workflow 400 can further include a descriptor 408 for the real property asset to be transacted. Furthermore, the dynamic workflow 400 can include a list of identified parties 402. A status indicator 406 can be included to indicate whether the closing actions to be performed by each party are still in progress. Also, the dynamic workflow 400 can include a target move-in feature 410 to indicate to all parties the final date in which the various closing actions must be complete.

The list of identified parties 402 can include at least the buyer and the seller associated with the real property asset. Additionally, the list 402 can include any number of the parties necessary in order to finalize the transaction. The list as shown in FIG. 4 identifies each of a buyer, a seller, a third-party escrow agent, the county, a lender, a co-signer, and one or more agents involved in the transaction. The list 402 may be dynamically populated as each party to the transaction is identified. As such, the workflow schedule 404 can correspondingly be changed or added to as the list of identified parties 402 is populated.

The workflow schedule 404 can include each of the identified parties to the transaction, and the various closing actions or tasks necessary to be completed by each party for finalization of the transaction. The workflow schedule 404 may also be dynamically populated as new tasks emerge or as submitted requests to the parties are complied with. AS shown in FIG. 4, each party to the transaction is assigned one or more closing actions to be completed by a specific date. An indicator (e.g., a checkbox) can be included proximate to each task, and can indicate whether a task has been completed. Additionally or as an alternative, any of the features of the workflow schedule 404 can be color coded, for example, to indicate whether tasks have been completed by the due date, or whether the specific party is late in completing the task.

The target move-in feature 410 can be a set date on which all tasks must be completed in order to allow the buyer to take possession of the real property asset. Alternatively, the target move-in feature 410 can be dynamic to reflect unforeseen contingencies, in which the move-in date must be pushed back. In such variations, specific identified parties (e.g., the buyer) can after the move-in date. Additionally or alternatively, the move-in date can be automatically altered as contingencies arise.

The status indicator 406 can indicate the overall status of the workflow. Additionally, the status indicator 406 can further indicate when contingencies arise, or when any number of the closing actions have been completed. For example, when the county approves of permitting for intended use of the real property asset, the status indicator can reflect so for a predetermined period of time. When all closing actions have been completed, the status indicator can reflect so, and the transaction can be finalized. In variations, the completed workflow 400 can be automatically transmitted to any of the identified parties.

FIG. 5 is a block diagram that illustrates a computer system upon which some embodiments described herein may be implemented. For example, in the context of FIG. 1, system 100 may be implemented using one or more servers such as described by FIG. 5. Likewise, methods such as described with FIG. 2 and FIG. 3 can be implemented using a computer or server such as described with FIG. 5.

In one implementation, computer system 500 includes processor 504, memory 506 (including non-transitory memory), storage device 510, and communication interface 518. Computer system 500 includes at least one processor 504 for processing information. Computer system 500 also includes the memory 506, such as a random access memory (RAM) or other dynamic storage device, for storing information and instructions to be executed by processor 504. The memory 506 also may be used for storing temporary variables or other intermediate information during execution of instructions to be executed by processor 504. The memory 506 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 (wireless or wireline). The communication interface 518 may communicate with bidders and auction participants using, for example, the Internet.

Embodiments described herein are related to the use of computer system 500 for implementing the techniques described herein. According to one embodiment, those techniques are performed by computer system 500 in response to processor 504 executing one or more sequences of one or more instructions contained in memory 506. Such instructions may be read into memory 506 from another machine-readable medium, such as storage device 510. Execution of the sequences of instructions contained in memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Those skilled in the art will appreciate that by automating the closing process for a real estate transaction via a computer-implemented method, significant efficiencies in time and cost may be realized. Further, by tightly managing the workflow through automated prompting and coordinated flow, risks in a deal falling through due to inefficient workflow scheduling may be minimized.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the invention is not limited to those precise examples. As such, many modifications and variations will be apparent to practitioners skilled in this art. Accordingly, it is intended that the scope of the invention be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

What is claimed is:

1. A computer-implemented method for managing closing of a real property asset transaction, the method being implemented by a computing device having one or more processors and interfaced with a communications network, the method comprising:
identifying parties involved in completing the transaction, the parties including at least a buyer and a seller;
automatically scheduling one or more closing actions to be performed by the buyer and the seller respectively, the one or more closing actions being necessary to finalize the transaction;
generating a dynamic workflow including the scheduled one or more closing actions;
transmitting the dynamic workflow to one or more of the parties; and
updating the dynamic workflow upon completion of each closing action.

2. The method of claim 1, further comprising, after a predetermined duration of time from transmitting the dynamic workflow, prompting the parties for documentation relating to completion of the one or more closing actions.

3. The method of claim 2, further comprising:
receiving signed documentation from the parties; and
storing the signed documentation in a database;
wherein updating the dynamic workflow is performed in response to receiving the signed documentation.

4. The method of claim 1, wherein the parties include a third-party escrow agent, and wherein automatically scheduling the one or more closing actions includes scheduling preliminary escrow actions to be performed by the third-party escrow agent.

5. The method of claim 4, and further comprising, in response to a completion of all closing actions in the dynamic workflow, initiating final closing actions to be carried out by the parties.

6. The method of claim 5, wherein the final closing actions include (i) distributing final documents for signature to the parties via a network, (ii) monitoring the status of the final documents for signature, (iii) receiving the final documents in a signed format from the parties via a network, and (iv) automatically requesting recordation of the signed documents via a network communication to a government entity.

7. The method of claim 1, wherein automatically scheduling the one or more closing actions is based on a type of real estate transaction.

8. The method of claim 1, wherein automatically scheduling the one or more closing actions is based on a geographic location of the real property of the real property transaction.

9. A system for managing workflow of a closing process associated with a real property transaction, the system comprising:
one or more processors; and
a memory resource storing instructions that, when executed by the one or more processors, cause the one or more processors to:
identify parties involved in completing the real property transaction, the parties including at least a buyer and a seller;
automatically schedule one or more closing actions to be performed by the buyer and the seller respectively, the one or more closing actions being necessary to finalize the real property transaction;
generate a dynamic workflow including the scheduled one or more closing actions;
transmit the dynamic workflow to one or more of the parties; and
update the dynamic workflow upon completion of each closing action.

10. The system of claim 9, wherein the instructions, when executed by the one or more processors, further cause the one or more processors to, after a predetermined duration of time from transmitting the dynamic workflow, prompting the parties for documentation relating to completion of the one or more closing actions.

11. The system of claim 10, wherein the instructions, when executed by the one or more processors, further cause the one or more processors to:
receive signed documentation from the parties; and
store the signed documentation in a database;
wherein updating the dynamic workflow is performed in response to receiving the signed documentation.

12. The system of claim 9, wherein the parties include a third-party escrow agent, and wherein automatically scheduling the one or more closing actions includes scheduling preliminary escrow actions to be performed by the third-party escrow agent.

13. The system of claim 12, wherein the instructions, when executed by the one or more processors, further cause the one or more processors to, in response to a completion of all closing actions in the dynamic workflow, initiating final closing actions to be carried out by the parties.

14. The system of claim 13, wherein the final closing actions include (i) distributing final documents for signature to the parties via a network, (ii) monitoring a status of the final documents for signature, (iii) receiving the final documents in a signed format from the parties via a network, and (iv) automatically requesting recordation of the signed documents via a network communication to a government entity.

15. The system of claim 9, wherein automatically scheduling the one or more closing actions is based on a type of real estate transaction.

16. The system of claim 9, wherein automatically scheduling the one or more closing actions is based on a geographic location of the real property of the real property transaction.

17. A non-transitory computer-readable medium storing instructions that, when executed by one or more processors, cause the one or more processors to:
identify parties involved in completing a transaction, the parties including at least a buyer and a seller;
automatically schedule one or more closing actions to be performed by the buyer and the seller respectively, the one or more closing actions being necessary to finalize the transaction;
generate a dynamic workflow including the scheduled one or more closing actions;
transmit the dynamic workflow to one or more of the parties; and
update the dynamic workflow upon completion of each closing action.

18. The non-transitory computer-readable medium of claim 17, wherein the instructions, when executed by the one or more processors, further cause the one or more processors to, after a predetermined duration of time from transmitting the dynamic workflow, prompting the parties for documentation relating to completion of the one or more closing actions.

19. The non-transitory computer-readable medium of claim 18, wherein the instructions, when executed by the one or more processors, further cause the one or more processors to:
receive signed documentation from the parties; and
store the signed documentation in a database;
wherein updating the dynamic workflow is performed in response to receiving the signed documentation.

20. The non-transitory computer-readable medium of claim 17, wherein the parties include a third-party escrow agent, and wherein automatically scheduling the one or more closing actions includes scheduling preliminary escrow actions to be performed by the third-party escrow agent.
